(19) United States
(12) Patent Application Publication
(10) Pub. No.: US 2006/0225284 A1
(43) Pub. Date: Oct. 12, 2006

(54) Composite roller header assembly and composite roller formed therewith

(75) Inventors: Duane V. Byerly, Lincoln, NE (US); David E. Sayker, Lincoln, NE (US); Kurt A. Polzin, Lincoln, NE (US); Joseph M. Gabriel, Raymond, NE (US)

Correspondence Address: QUARLES & BRADY LLP, 411 E. WISCONSIN AVENUE, SUITE 2040, MILWAUKEE, WI, 53202-4497, US

(73) Assignee: Rexnord Industries, Inc.

(21) Appl. No.: 11/101,865

(22) Filed: Apr. 8, 2005

(51) Int. Cl. B21D 53/00; F16C 35/08; F16C 13/00

(52) U.S. Cl. 29/895.32; 29/895.22; 464/184; 492/47

(57) ABSTRACT

A header assembly for use in a composite roller includes a core having a radially outwardly facing surface. A head is formed around the outwardly facing surface and extends radially from the outwardly facing surface. The head includes a first axially extending face and a second axially extending face facing away from the first axially extending face. In one embodiment, an axially opening channel is formed in the head for receiving at least one balancing weight. In another embodiment, the head is formed from a curable moldable material molded around a metal core.

### CROSS REFERENCES TO RELATED APPLICATIONS

Not Applicable.

### STATEMENT REGARDING FEDERALLY SPONSORED RESEARCH

Not Applicable.

### BACKGROUND OF THE INVENTION

This invention relates to composite precision rollers, and more particularly to a composite roller header assembly, composite rollers formed therewith, and a method of forming composite rollers formed therewith.

Precision rollers are used as a web handling device on process equipment in various industries: materials manufacturing, printing, processing and converting. The rollers perform various functions including transporting, processing, directing, and storing sheet material. These materials could include but are not limited to films, foils, paper, wovens, non-wovens and laminates. In order to properly perform these functions, the rollers must accurately rotate on center about bearings, deflect as predicted when a web load is applied, start and stop quickly (proper inertia) as the web requires, and offer the correct surface finish to properly slip or provide friction as the application requires. Other design criteria may be required, depending on the application.

Composite rollers have been used in industrial applications for many years and are now being used increasingly as web handling devices because of their superior performance and less cost compared to metal rollers. Carbon fiber and epoxy resin are the most common materials used to fabricate composite roller bodies due to the high stiffness to weight ratio of the carbon fiber material. Composite materials offer the benefits of low mass, less inertia and corrosion resistance that conventional metals can not provide. Because of higher stiffness/weight ratio composite rollers have higher natural frequencies and can operate at higher speeds and longer spans than metal rollers. Converting machines can now be designed to handle wider webs and operate with faster throughput than can be demonstrated with metal rollers. Moreover, lighter rollers formed from composite materials could result in requiring fewer rollers in a converting machine which should reduce the machine footprint.

With the acceptance of composite rollers in industrial applications, efforts to further improve the roller characteristics has drawn the attention of engineers to header assemblies that support the roller ends. Header assemblies are received in the roller ends, and can have either a live shaft or a dead shaft. A live shaft header assembly has a stub shaft, or journal, that extends from a head received in each end of a tubular body to support the roller end. The header assembly, and thus the stub shaft, is rigidly attached to, and rotates with, the body. Driven rollers transmit torsional load through the journal into the body of the roller. A dead shaft header assembly includes a bearings concentrically fixed to a head received in the roller body end. A shaft passes though the header assembly and roller body to support the roller end, but does not rotate with the roller.

The head is concentric with the body of the roller, and joins the roller body to the journal or bearing to form the roller. In metal rollers, the head is usually pressed into or welded to the body of the roller, are concentric with the body of the roller. In composite rollers, the head is either bonded to the roller body or pressed into either the composite roller body.

Imperfections in the manufacturing process makes it impossible to produce a balanced roller (i.e. a roller that can rotate at high speeds without undue vibration). As a result high speed rollers must be balanced prior to use. Balancing a roller often requires affixing weights to the inside of the roller body or by drilling radially extending holes through the roller body. This process is time consuming and can damage the roller if done improperly,

In a known header assembly used in a composite roller disclosed in U.S. Pat. No. 6,299,733, the header assembly includes a head bonded to a journal to form a live shaft roller. The head is formed by winding composite fibers in a resin matrix onto the journal. U.S. Pat. No. 6,299,733 discloses a method of balancing the roller which includes drilling a series of axially extending holes into the face of the header. This method requires a step of forming the axially extending holes in the header face after the head has been cured, and then slipping weights, as required, into the holes to balance the roller. Unfortunately, forming the header face is a manufacturing step that requires equipment and labor. Moreover, weights can only be received in the preformed axially extending holes which limits the ability to properly balance the roller.

### SUMMARY OF THE INVENTION

The present invention provides a header assembly, composite roller, and method of manufacture, that is simple and can simplify roller balancing. The header assembly includes a core having a radially outwardly facing surface. A head is formed around the outwardly facing surface and extends radially from the outwardly facing surface. The head includes a first axially extending face and a second axially extending face facing away from the first axially extending face. In one embodiment, an axially opening channel is formed in the head for receiving at least one balancing weight. In another embodiment, the head is formed from a curable moldable material molded around a metal core. Advantageously, the method disclosed herein can be used to make a composite roller having either a live shaft or a dead shaft.

A general objective of the invention is to provide a header assembly that is simple to balance. This objective is accomplished by forming a channel in the head for receiving a balancing weight at any point around the roller axis.

Another objective of the present invention is to provide a composite header assembly that is easy to manufacture and versatile. This objective is accomplished by molding a head formed from a curable material around a metal core to form the header assembly.

Another objective of the present invention is to provide a method of making a composite roller having either a live shaft or a dead shaft. The objective is accomplished by molding a head around the core using a mold having an opening that is closed by the core to accommodate either an annular ring for a dead shaft roller or a journal for a live shaft roller.

The foregoing and other objects and advantages of the invention will appear from the following description. In the description, reference is made to the accompanying drawings which form a part hereof, and in which there is shown by way of illustration a preferred embodiment of the invention.

### BRIEF DESCRIPTION OF THE DRAWINGS

FIG. 1 is an elevational view of a composite roller incorporating the present invention:

FIG. 2 is a cut away view along line 2-2 of FIG. 1;

FIG. 3 is a perspective view of an embodiment of a live shaft header assembly suitable for use in the roller of FIG. 1;

FIG. 4 is a cross sectional view of the live shaft header assembly of FIG. 3 with a balancing weight and cover;

FIG. 5 is a perspective view of an embodiment of a dead shaft header assembly suitable for use in the roller of FIG. 1;

FIG. 6 is a cross sectional view of the dead shaft header assembly of FIG. 5 assembled with a bearing and shaft, and including a balancing weight and cover; and

FIG. 7 is a cross sectional view of a mold set up for molding the header assembly of FIG. 3; and

FIG. 8 is a cross sectional view of the mold of FIG. 7 set up for molding the header assembly of FIG. 5.

Before embodiments of the invention is explained in detail, it is to be understood that the invention is not limited in its application to the details of the construction and the arrangements of components set forth in the following description or illustrated in the drawings. The invention is capable of other embodiments and of being practiced or being carried out in various ways. Also, it is understood that the phraseology and terminology used herein is for the purpose of description and should not be regarded as limiting.

### DESCRIPTION OF THE PREFERRED EMBODIMENT

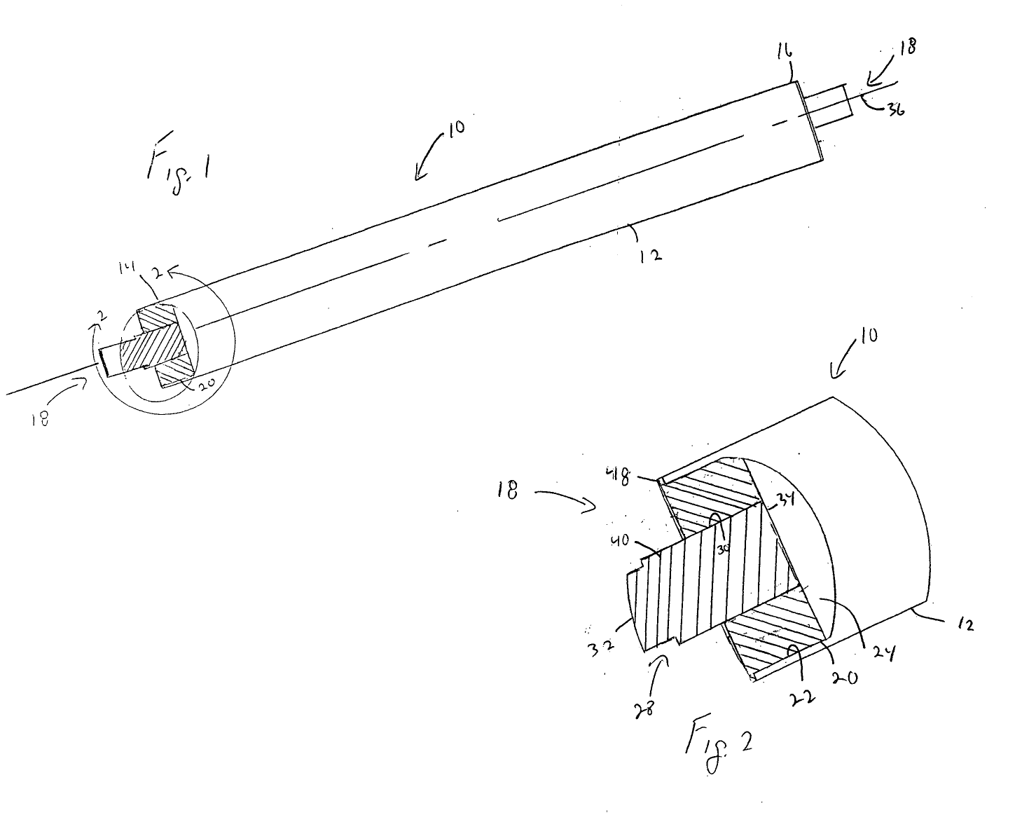

A precision roller 10 shown in FIGS. 1 and 2 includes a tubular body 12 having open ends 14, 16. Each open end 14, 16 receives a header assembly 18 including a head 20 bonded to a core 28. Each header assembly 18 supports one end of the tubular body 12. The head 20 of each header assembly 18 defines a radially outwardly facing surface 22 fixed relative to an inner surface 24 of the tubular body 12 to fix the header assembly 18 to the tubular body 12.

The tubular body 12 is known in the art, and is preferably a fibrous composite tube, such as formed from a continuous reinforcing fiber and polymer matrix in any one of a known manner, such as casting, filament winding, hand lay-up, and roller wrapping. The reinforcing fiber can be any suitable fiber, such as carbon, glass, wire, and the like, which is embedded in the polymer matrix. The polymer matrix can be any suitable material known in the art, such as a thermoset or thermoplastic resin which is cured to form the tubular body. Although a fibrous composite tube having a circular cross section is preferred, the tubular body 12 can have any cross section that defines an inner surface, such as a multi-sided geometric shape, oval, and the like, which is formed from any material bondable to the header assemblies 18, such as plastic, metal and the like.

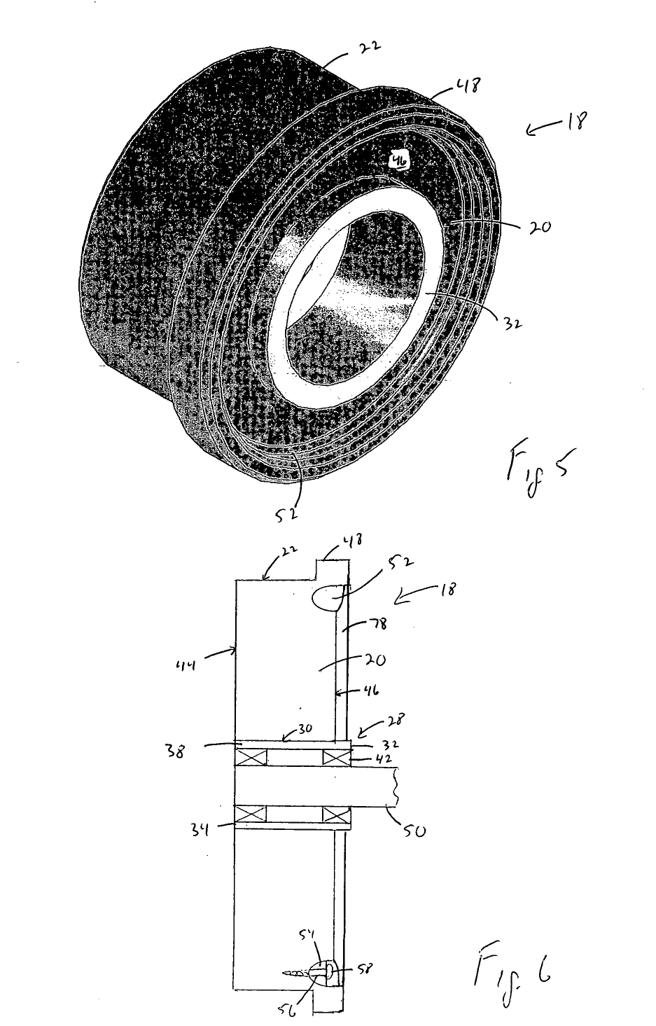

Each header assembly 18 includes a core 28 with the head 20 fixed thereto. In one embodiment shown in FIGS. 1-4, the header assembly 18 incorporates a live shaft design in which the core 28 is a journal 40 having a radially outwardly facing surface 30 extending between opposing ends 32, 34. The journal 40 is coaxial with the roller axis 36 extending through the ends 32, 34, and can be stepped, such as shown in FIG. 1-4, or straight without departing from the scope of the invention. In another embodiment shown in FIGS. 5 and 6, the header assembly 18 incorporates a dead shaft design in which the core 28 is an annular ring 38 having a radially outwardly facing surface 30 extending between opposing ends 32, 34. The annular ring 38 is coaxial with the roller axis 36 extending through the ends 32, 34. A bearing 42 mounted in the annular ring 38 engages a fixed shaft 50 extending through the roller 10. In both embodiments, the header assembly 18 includes the radially outwardly facing surface 22 that is bonded to a radially inwardly facing inner surface 24 of the tubular body 12.

A metal core 28, such as formed from steel, is preferred, because of the strength characteristics of steel. The core 28, however, can be formed from any suitable material capable of withstanding the torque and moment applied in the desired application. Moreover, although an outwardly facing surface 30 having a circular cross section is disclosed, the outwardly facing surface 30 can define a non-circular cross section, such as a multi-sided geometric shape, without departing from the scope of the invention. In a preferred embodiment, one or more locking structures, such as flats, grooves, knurling, and the like, are formed in the outwardly facing surface 30 to rotatably lock the head 20 relative to the core 28.

The head 20 is rotatably and axially bonded to the core 28, and defines the radially outwardly facing surface 22 radially spaced from the radially outwardly facing surface 30 of the core 28. Advantageously, the head 20 can absorb transitional torque and moment loads as the composite roller 10 changes rotational speeds to avoid premature failure. Preferably, the head 20 is formed from a curable material molded around the radially outwardly facing surface 30 of the core 28 to form a header assembly 18 having an axially facing inner face 44 and an axially facing outer face 46 joined by the radially outwardly facing surface 22.

As shown in FIGS. 1-6, a lip 48 extending radially from the radially outwardly facing surface 22 proximal the outer face 46 abuts the end 14 of the body to prevent the header assembly 18 from slipping past the body end 14 into the body 12. A circumferential axially opening channel 52 formed in the head 20 receives balancing weights 54 to balance the roller 10. In one embodiment, shown in FIG. 4, the channel 52 is defined by the junction of the planar outer face 46 of the head 20 and a radially inwardly facing wall 60 of the lip 48. In another embodiment, shown in FIG. 6, the channel 52 is formed proximal the lip 48 and extends axially inwardly into the outer face 46.

The channel 52 radially secures the balancing weights 54 received therein against centrifugal forces. Preferably, the channel 52 is formed proximal the radially outwardly facing surface 22 of the head 20 to minimize the mass of the weights 54 required to balance the composite roller 10. However, the channel 52 can be formed anywhere between the core 28 and outwardly facing surface 22 without departing from the scope of the invention. Advantageously, the channel 52 allows the weights 54 to be located at any position around the roller axis 36 to properly balance the roller 10. Preferably, the channel 52 is continuous to receive the weights 54 at any point around the roller axis 36. However, ribs (not shown) radially traversing the channel 52 can be provided to maintain the stiffness of the head 20 without departing from the scope of the invention.

One or more of the weights 54 are received in the channel 52, and each weight 54 includes an axially extending throughhole 56. A self tapping screw 58 extending through the throughhole 56 secures the weight 54 in the channel 52 to the head 20 to balance the composite roller 10. Although self tapping screws 58 are preferred, any means for securing the weight 54 in the channel 52 to the head 20, such as adhesives, interference fit, bolts, and the like, can be used without departing from the scope of the invention.

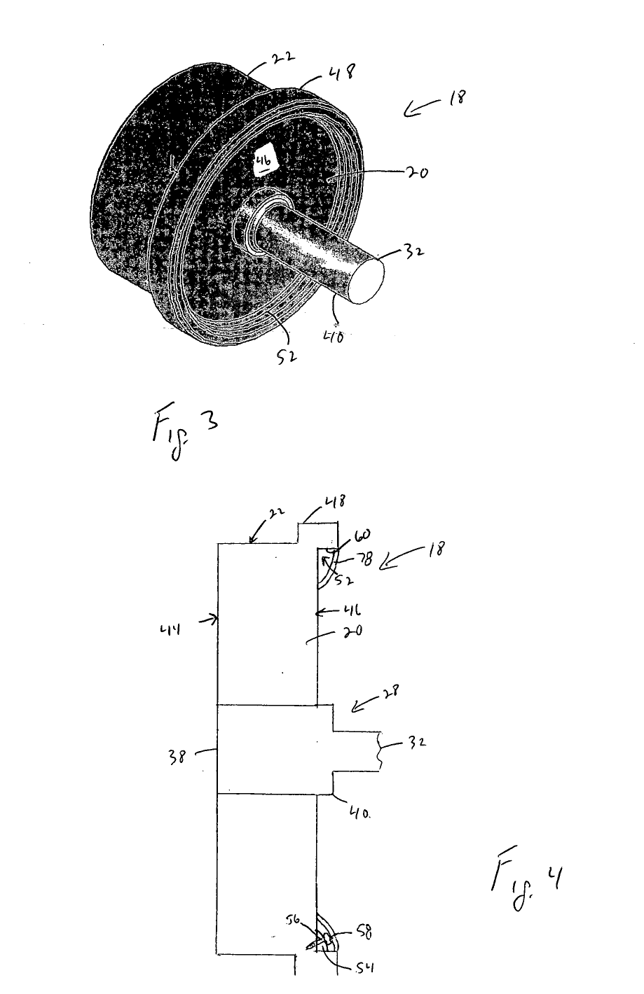

Referring to FIGS. 3-6, the inner face 44 faces into the tubular body 12, and has an “as cast” surface which is moderately roughened. Of course, the inner face 44 can be molded or formed, such as by machining, to further reduce the weight of the header assembly 18 without departing from the scope of the invention. Preferably, the outer face 46 is molded to include an axially opening channel 52 spaced radially inwardly from the radially outwardly facing surface 22 of the head 20.

The head 20 can be made from a variety of moldable curable materials that can be cured to form a resilient material. Preferably, the head 20 is formed from an epoxy or vinyl ester matrix system combined with a filler material consisting of short or long fiber glass strands, metallic fibers, beads or other media. The filler material gives strength and stiffness properties to the resin matrix. Although an epoxy or vinyl ester matrix system with filler material is preferred, any curable resin with or without filler material can be used to form the head 20 without departing from the scope of the invention.

Advantageously, once the curable material has been cured to form the head 20, the radially outwardly facing surface 22 of the head 20 can be shaped, such as by grinding, machining, and the like, to conform with the inner surface 24 of the tubular body 12. Preferably, the radially outwardly facing surface 22 of the head 20 has a circular cross section that conforms with the inner surface 24 of the tubular body 12 to minimize manufacturing costs of the header assembly 18.

The radially outwardly facing surface 22 of the head 20 is preferably bonded to the inner surface 24 of the tubular body 12 by an adhesive. Preferably, the adhesive is an aerospace epoxy adhesive that forms a strong adhesive bond between the head 20 and tubular body 12 capable of resisting torque and moment loads applied to the composite roller 10. However, any suitable adhesive can be used. Although bonding the head 20 to the inner surface 24 of the tubular body 12 using an adhesive is preferred, if the resulting composite roller 10 is a standard length, or made to order, the head 20 can be bonded to the inner surface 24 of the tubular body 12 by forming the head 20 after it has been inserted into the tubular body end 14 to bond the head 20 to the tubular body inner surface 24 without an adhesive or forming the tubular body 12 around the completed header assemblies 18.

A cover 78 fixed over the outer face 46 of the head 20 covers the balancing weights 54 to provide a finished look to the roller 10. Advantageously, the cover 78 can contain the balancing weights 54 if they become loose during roller operation. The cover 78 is fixed to the head 20 using methods known in the art, such as adhesives, mechanical fasteners, and the like. Advantageously, if the channel 52 is formed at the junction of the outer face 46 and lip 48, the cover 78 can be a trim ring, such as shown in FIG. 4, that only covers the channel 52 and balancing weights 54.

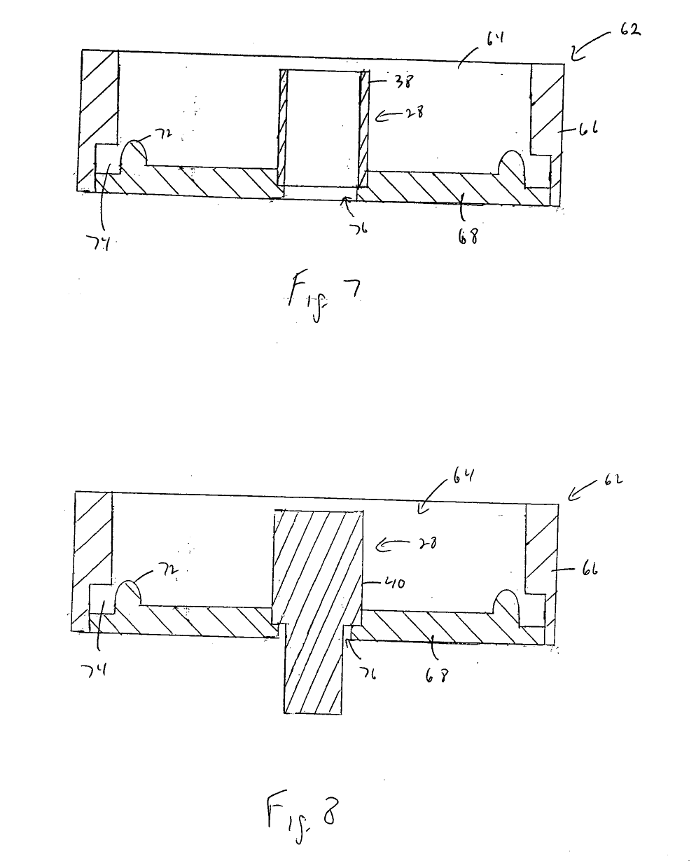

In the embodiment disclosed herein, each header assembly 18 is formed by providing the metal core 28 that is secured inside a mold 62, such as shown in FIGS. 7 and 8. The mold 62 has an open top 64 and includes an upwardly extending circumferential wall 66 joined by a bottom wall 68. The circumferential wall 66 is shaped to form the radially outwardly facing surface 22 of the head 20. The bottom wall 68 positions an end of the metal core 28, and includes a ridge 72 spaced radially inwardly from the circumferential wall 66 to form the channel 52 in the outer face 46 of the head 20, such as the embodiment shown in FIG. 6. A channel 74 formed in the bottom wall 68 is aligned with the circumferential wall 66 to form the lip 48. Advantageously, the mold 62 includes a central opening 76 that is closed by the core 28. The central opening 76 allows the journal 40 to extend through when molding a live shaft header assembly, such as shown in FIG. 8, and remains closed by the annular ring 38 when molding a dead shaft header assembly, such as shown in FIG. 7.

The curable material forming the head 20 is poured into the open top 64 of the mold 62 around the radially outwardly facing surface 30 of the core 28, and then allowed to cure. Of course, other methods for molding the head, such as injection molding, can be used without departing from the scope of the invention. Preferably, the curable material fills grooves, holes, voids, and around any other locking structure formed in or on the core radially outwardly facing surface 30 to lock the head relative to the core 28 upon curing of the curable material. Advantageously, upon curing, the curable material shrinks around the core 28 and locks down tight onto the core 28 which further prevents any relative movement between the head 20 and core 28. The shrinking also induces a locking stress on the core 28 which increases the friction between the core 28 and the head 20 and improves the load transferability during the roller operation.

Once the header assembly 18 is removed from the mold 62, the head 20 can then be further shaped, such as by machining, grinding, and the like, to form the radially outwardly facing surface 22 of the head 20 such that it conforms with the inner surface 24 of the tubular body 12. Of course, the head 20 can be shaped to have keys and other structure, as desired, however, a head 20 having a circular cross section is preferred.

The adhesive is then applied to at least one of the inner surface 24 of the tubular body 12 and the radially outwardly facing surface 22 of the head 20, and the head 20 is slipped into the end 14 of the tubular body 12. Curing the adhesive bonds the head 20 to the tubular body 12 and fixes the header assembly 18 in the tubular body end 14. The second header assembly 18 is fixed in the other end 16 of the tubular body 12 using the same procedure described above if a second header assembly 18 is desired. Of course, if an adhesive is not desired, the header assembly can be pressed into the end 14 of the tubular body to form an interference fit or fixed to the tubular body using mechanical fasteners, such as bolts, screws, and the like.

Once the roller 10 is formed, the roller 10 is balanced by fixing the balancing weights 54 in the channel 52, as required. If desired, the cover 78 is then fixed to the head 20 to cover the channel 52.

While there has been shown and described what are at present considered the preferred embodiment of the invention, it will be obvious to those skilled in the art that various changes and modifications can be made therein without departing from the scope of the invention defined by the appended claims. Therefore, various alternatives and embodiments are contemplated as being within the scope of the following claims particularly pointing out and distinctly claiming the subject matter regarded as the invention. For example, in one embodiment of the present invention, the head 20 can be molded, or cast, from metal and formed at the same as the core 28 to form a metal header assembly 18 having a channel 52 for receiving the balancing weights 54.

We claim:

1. A header assembly comprising:
a core having a radially outwardly facing surface;
a head formed around said outwardly facing surface and extending radially from said outwardly facing surface, said head including a first axially extending face and a second axially extending face facing away from said first axially extending face; and
an axially opening channel formed in said head for receiving at least one balancing weight.

2. The assembly as in claim 1, in which said head includes an axially extending circumferential lip, and said channel is formed at a junction of said lip and said first axially extending face.

3. The assembly as in claim 1, in which said head is formed from a curable material.

4. The assembly as in claim 1, in which said head is bonded to said core.

5. The assembly as in claim 1, in which said core is selected from a group consisting of an annular ring and a journal.

6. The assembly as in claim 1, in which locking structure formed on said outwardly facing surface of said core locks said head relative to said core.

7. The assembly as in claim 1, including a balancing weight received in said channel and fixed relative to said head.

8. The assembly as in claim 1, including a cover fixed relative to said head covering said channel.

9. A composite roller comprising:
a tubular shaft formed from a composite material and having opposing open ends defining an inner surface; and
at least one composite header assembly received in one end of said opposing ends, said header assembly including a core having a radially outwardly facing surface, a head formed around said outwardly facing surface and fixed relative to said tubular shaft, said head including a first axially extending face facing into said tubular shaft and a second axially extending face facing away from said first axially extending face; said head including an axially opening channel for receiving at least one balancing weight.

10. The roller as in claim 9, in which said head includes an axially extending circumferential lip, and said channel is formed at a junction of said lip and said first axially extending face.

11. The roller as in claim 9, in which said head is formed from a curable material.

12. The roller as in claim 9, in which said head is bonded to said core.

13. The roller as in claim 9, in which said core is selected from a group consisting of an annular ring and a journal.

14. The roller as in claim 9, in which locking structure formed on said outwardly facing surface of said core locks said head relative to said core.

15. The roller as in claim 9, including a balancing weight received in said channel and fixed relative to said head.

16. The roller as in claim 9, including a cover fixed relative to said head covering said channel.

17. A method of making a composite roller, said method comprising:
pouring a moldable material into a mold to form a head around a core, said mold including an opening closed by said core; and
hardening said moldable material to form the head and fix the head to the core;
inserting said head into one end of a tubular body; and
fixing said head relative to said tubular body to make the roller.

18. The method as in claim 17, including forming a channel in said head

19. The method as in claim 18, including fixing a cover over said channel.

20. The method as in claim 17, including balancing the roller by fixing at least one balancing weight in said channel.

21. The method as in claim 17, in which said core is selected from a group consisting of an annular ring and a journal.

22. The method as in claim 17, in which said moldable material includes a curable resin, and hardening said moldable material includes curing said resin.

23. The method as in claim 22, in which said core is formed from a metal, and curing said resin causes said head to lock onto said core.
